(19) United States
(12) Patent Application Publication
(10) Pub. No.: US 2023/0043251 A1
(43) Pub. Date: Feb. 9, 2023

(54) SUBMERSION-COOLED POWERTRAIN FOR ELECTRIC HYDROFOIL BOARD

(71) Applicants: Ryan Rasmussen, Troy, NY (US); Foil Boarding Company, Inc., Pensacola, FL (US)

(72) Inventors: Ryan Rasmussen, Troy, NY (US); Kyle Roarke, Denver, CO (US); Daniel Goodman, Schnectady, NY (US); Jesse Hughson, Rochester, NY (US)

(21) Appl. No.: 17/791,509

(22) PCT Filed: Jan. 7, 2021
(86) PCT No.: PCT/US21/12562

§ 371 Date: Jul. 7, 2022

Related U.S. Application Data
(60) Provisional application No. 62/957,851, filed on Jan. 7, 2020.

(51) Int. Cl. B63B 32/10; B63B 32/60; B63B 1/24; B63B 79/40; B63H 21/21; H02K 5/132; H02K 5/18; H02K 9/22; H02K 11/00; H02K 11/33

(52) U.S. Cl. CPC B63B 32/10; B63B 32/60; B63B 1/246; B63B 79/40; B63H 21/21; H02K 5/132; H02K 5/18; H02K 9/227; H02K 11/0094; H02K 11/33; B63H 2021/216

(57) ABSTRACT

An electric hydrofoil board having a submersion-cooled powertrain is provided. A powertrain assembly, which includes a motor housed in a motor assembly and an electronic speed controller housed in a nose cone assembly that is fastened to the motor assembly, is attached to a lower end of a mast of the hydrofoil board so that the powertrain assembly remains submerged at all times during normal use of the hydrofoil board in a body of water. The flow of water around the powertrain assembly during normal use cools heat-generating components of the electronic speed controller and motor.

### CROSS REFERENCES

This application is a U.S. National Stage application of PCT Application No. PCT/US21/12562, filed on Jan. 7, 2021, which claims priority to U.S. Provisional Application No. 62/957,851, filed on Jan. 7, 2020, which application is incorporated herein in its entirety by reference.

### FIELD OF THE INVENTION

The present invention relates generally to an electric hydrofoil board having a passively cooled powertrain and a passively cooled powertrain assembly for installation on an electric hydrofoil board.

### BACKGROUND

Electric hydrofoils, sometimes referred to as eFoils, electric surfboards, hydrofoil boards, or simply foilboards, are becoming increasingly popular in the watersports industry. These devices generally include a board, which is similar to a surfboard or a wakeboard, for supporting a rider and a hydrofoil attached to the board. The hydrofoil extends below the surface of the water and causes the board to rise above the surface of the water once a certain speed is reached. Electric hydrofoils have an electric motor that powers a propeller. Both the hydrofoil, which is commonly referred to as “wings” in the industry, and the motor/propeller assembly are attached to a mast that supports the board above the surface of the water when the hydrofoil reaches the speed necessary to cause the board to rise out of the water.

In order to function, electric hydrofoils require a battery as a power source and an electronic speed controller (ESC) for the rider to control the speed of the hydrofoil. Generally, a rider starts with the foilboard at rest and slowly increases the speed. The rider may choose to operate the foilboard at a low speed, which may cause the board to move along the surface of the water more like a traditional surfboard or wakeboard. However, the rider may increase the speed in order to cause the board to rise above the surface of the water. The rider would generally increase the speed slowly so that the board remains stable for the rider.

Electric hydrofoils, like most other forms of electric and internal combustion engine (ICE) propelled vessels and watercraft, have fairly large powertrains to overcome the drag developed at high speeds in a marine environment. These electric powertrains, although typically more efficient than equivalent ICE counterparts, still only convert a portion of the input electrical power to useable rotational work, thereby generating “waste” heat in the process. This waste heat must be removed from the system as it is generated during normal use in order to keep component temperatures at safe operational limits. In known electric hydrofoil designs, the electronic speed controller, along with the battery, are typically housed inside a cavity within the board, the top of which supports the rider. In these known devices, waste heat is typically removed from the ESC by using liquid cooling pumps to pump water sourced from the body of water in which the hydrofoil is being operated, up the mast through an internal channel, and into the cavity within the board where it can flow around the various electronic components to remove heat. The cooling water is then dumped back into the body of water in which the hydrofoil is being operated. Such cooling systems, although effective, require some additional complexity due to the necessary plumbing system, as well as more connections for the user to set up each time they use the hydrofoil. In addition, the cooling passages and orifices can become clogged with debris typically found in a marine environment such as sand, mud, silt, seaweed, and other foreign objects. The cooling system may require maintenance by the end user or service from the manufacturer if it becomes clogged, which may diminish the effectiveness of the system in cooling the ESC.

Other known hydrofoil designs avoid these problems by utilizing heat sinks to transfer heat away from the ESC without using a cooling liquid. Instead, the electronics may be attached directly to a large metallic heat sink, which typically protrudes from the bottom of the board and is thus exposed to air and/or water as the board moves. Such a design offers more reliability than a liquid cooling system but is typically less efficient at removing heat. Such a system also typically necessitates the use of a large quantity of metal alloy to effectively transfer heat. Thus, the addition of a heat sink may significantly increase the overall weight of such hydrofoils, which are typically constructed of lighter composites wherever possible in order to minimize weight.

Accordingly, a need exists in the art for an improved electric hydrofoil board and a powertrain assembly for installation on the electric hydrofoil board that can be cooled more efficiently while minimizing the overall weight of the hydrofoil board and the complexity of the cooling system.

### SUMMARY

In one aspect, an electric hydrofoil board having a submersion-cooled powertrain is provided. The hydrofoil board comprises a board, a mast attached to a bottom side of the board and extending downwardly from the board, a hydrofoil attached to a bottom end of the mast, and a powertrain assembly attached to the mast. The powertrain assembly comprises a motor and an electronic speed controller operably coupled to the motor and configured to vary the speed of the motor. A propeller is operably coupled to the motor, and a battery is operably connected to the electronic speed controller in order to provide power to the motor at variable speeds. During normal use, a rider stands on a top side of the board while the mast, including the hydrofoil attached to the mast, extends down into a body of water in which the hydrofoil board is being operated. The powertrain assembly is disposed at a position on the mast so that the powertrain assembly is also submerged when the electric hydrofoil board is in an upright position for normal use in water. Because the powertrain assembly, which houses the electronic speed controller, is submerged during normal use, the flow of water around the body of the powertrain assembly transfers heat away from the electronic speed controller and into the body of water in which the hydrofoil board is being operated. The electric hydrofoil board does not require any supplemental cooling system for cooling the electronic speed controller, such as a water pump and associated plumbing for circulating coolant around the electronic speed controller.

The powertrain assembly is configured to effectively transfer heat produced by the electronic speed controller housed within the interior of the powertrain assembly to external walls of the powertrain assembly so that the heat may ultimately be transferred into the surrounding water flowing around the powertrain assembly as the hydrofoil board moves through the water. To facilitate effective heat transfer, the powertrain assembly may include a combination of cooling features. The powertrain assembly preferably has external cooling fins disposed on an exterior of the powertrain assembly to provide increased surface area for heat transfer. The powertrain assembly preferably also includes internal heat transfer components, which may include heat sinks, thermal pads, and a thermal potting compound injected into voids surrounding components of the electronic speed controller. The body of the powertrain assembly is preferably constructed of aluminum, and the cooling features provide efficient heat transfer to the aluminum external walls of the body of the assembly.

Because the electronic speed controller is passively cooled by the flow of water around the powertrain assembly during normal operation of the hydrofoil board, the present hydrofoil board having a submerged powertrain assembly provides a number of advantages over conventional electric hydrofoil board designs. The present passive cooling system ensures reliable, nearly maintenance-free cooling of the electronic speed controller, as well as the motor. In addition, the present system condenses the powertrain assembly into a single uniform unit with a reduced number of required components, which does not require a water pump or associated plumbing components. Positioning the assembly housing the electronic speed controller below the water line eliminates much of the resistance in the thermal network and thus greatly increases the cooling capability of the present system, which allows for greater power levels of the electric motor and thus for better performance of the hydrofoil board. In addition, no additional connections are required of the user upon assembly, and no maintenance of the submersion-cooled powertrain assembly is required beyond a rinse with fresh water after use to prevent corrosion.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### DESCRIPTION OF THE DRAWINGS

These and other features, aspects, and advantages of the present invention will become better understood with regard to the following description, appended claims, and accompanying drawings where:

FIG. 1 shows a perspective view of an electric hydrofoil board in accordance with the present disclosure.

FIG. 2 shows a side elevational view of an electric hydrofoil board in accordance with the present disclosure.

FIG. 3 shows a cross-sectional view of an electric hydrofoil board in accordance with the present disclosure.

FIG. 4 shows a partial cross-sectional view of an electric hydrofoil board in accordance with the present disclosure.

FIG. 5 shows a perspective view of a board for use with an electric hydrofoil board in accordance with the present disclosure.

FIG. 6 shows a perspective view of a powertrain assembly in accordance with the present disclosure.

FIG. 7 shows an exploded view of a powertrain assembly in accordance with the present disclosure.

FIG. 8 shows a side elevational view of components of a nose cone assembly in accordance with the present disclosure.

FIG. 9 shows a side elevational view of the nose cone assembly components shown in FIG. 8 fastened together in accordance with the present disclosure.

FIG. 10 shows a perspective view of one half of a nose cone assembly in accordance with the present disclosure.

FIG. 11 shows a side elevational view of one half of a nose cone assembly with components of an electronic speed controller installed therein in accordance with the present disclosure.

FIG. 12 shows a perspective view of one half of a nose cone assembly with components of an electronic speed controller installed therein in accordance with the present disclosure.

FIG. 13 shows a cross-sectional view of the half of the nose cone assembly with components of an electronic speed controller installed therein as shown in FIG. 12 along line 13-13.

FIG. 14 shows a perspective view of a motor assembly coupled to one half of a nose cone assembly in accordance with the present disclosure.

### DETAILED DESCRIPTION

The present invention provides an electric hydrofoil board having a passively cooled powertrain and a passively cooled powertrain assembly for installation on an electric hydrofoil board in accordance with the independent claims. Preferred embodiments of the invention are reflected in the dependent claims. The claimed invention can be better understood in view of the embodiments described and illustrated in the present disclosure, viz. in the present specification and drawings. In general, the present disclosure reflects preferred embodiments of the invention. The attentive reader will note, however, that some aspects of the disclosed embodiments extend beyond the scope of the claims. To the respect that the disclosed embodiments indeed extend beyond the scope of the claims, the disclosed embodiments are to be considered supplementary background information and do not constitute definitions of the invention per se.

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

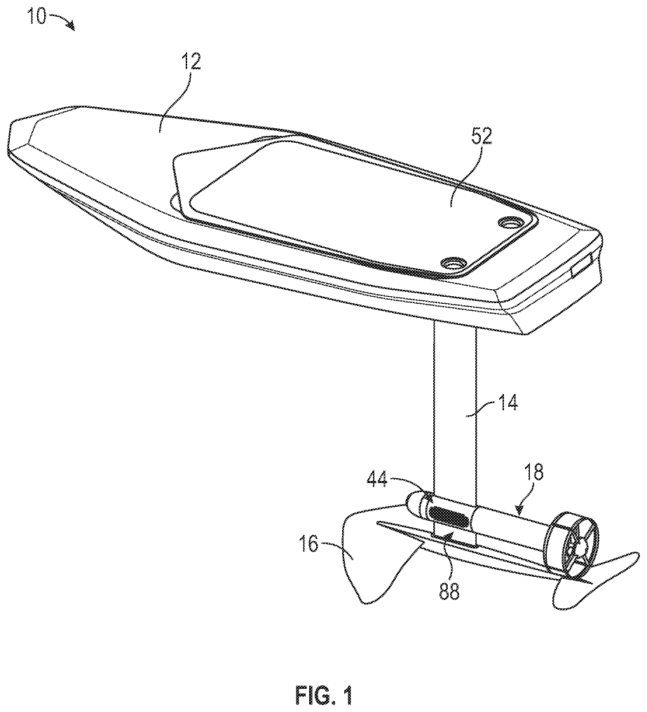

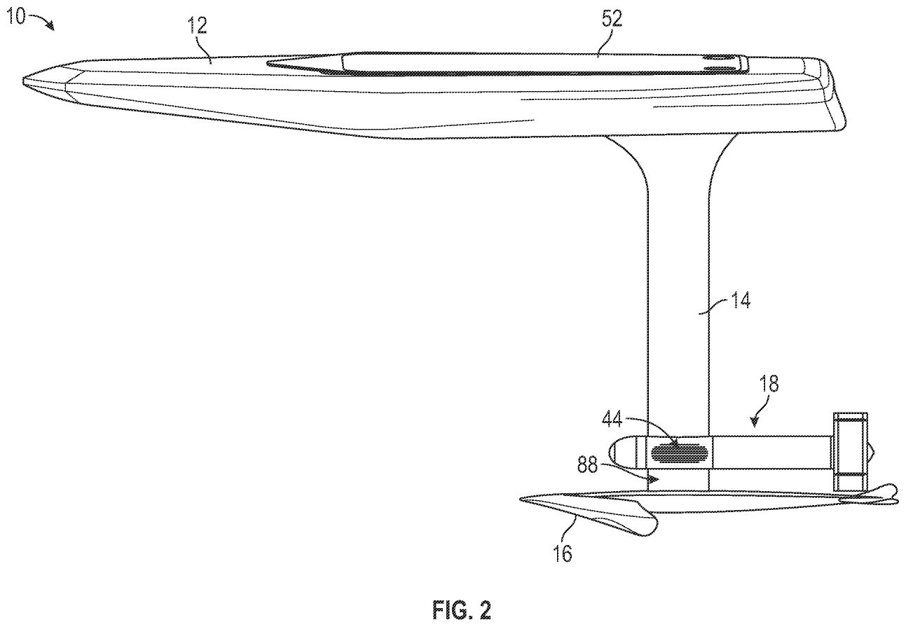

FIGS. 1 and 2 illustrate an electric hydrofoil board 10 having a submersion-cooled powertrain assembly 18 for driving the hydrofoil board 10. The electric hydrofoil board 10 comprises a board 12 for supporting a rider, a mast 14 attached to a bottom side of the board 12 and extending downwardly from the board 12, a hydrofoil 16 attached to a bottom end 88 of the mast 14, and a powertrain assembly 18 attached to the mast 14. The powertrain assembly 18 comprises a motor 28 and an electronic speed controller (ESC) 36 operably coupled to the motor 28 and configured to vary the speed of the motor 28. The powertrain assembly 18 is disposed at a position on the mast 14 so that the powertrain assembly 18 is submerged when the electric hydrofoil board 10 is in an upright position for normal use in water. FIG. 2 illustrates the electric hydrofoil board 10 in an upright position for normal operation. The powertrain assembly 18 is preferably attached to a lower end 88 of the mast 14 and disposed at a position above the hydrofoil 16, as best seen in FIGS. 1-3. The powertrain assembly 18 includes internal heat-generating components that require cooling during normal operation of the hydrofoil board 10 in a body of water. The submerged powertrain assembly 18 is passively cooled by the flow of water around the assembly 18 as the hydrofoil board 10 moves through the water during normal operation. An active coolant system is not required.

FIG. 6 illustrates the powertrain assembly 18 detached from the mast 14 of the hydrofoil board 10. The powertrain assembly 18 preferably has a tubular body with a rounded nose cone 24 at a front end and a propeller 30 at a back end. The propeller 30 may have a guard 32 to protect the blades of the propeller 30 from damage during normal operation and to protect users from injury. The tubular shape of the body of the powertrain assembly 18 may provide a smooth tubular profile to reduce drag as the assembly 18 moves through the water.

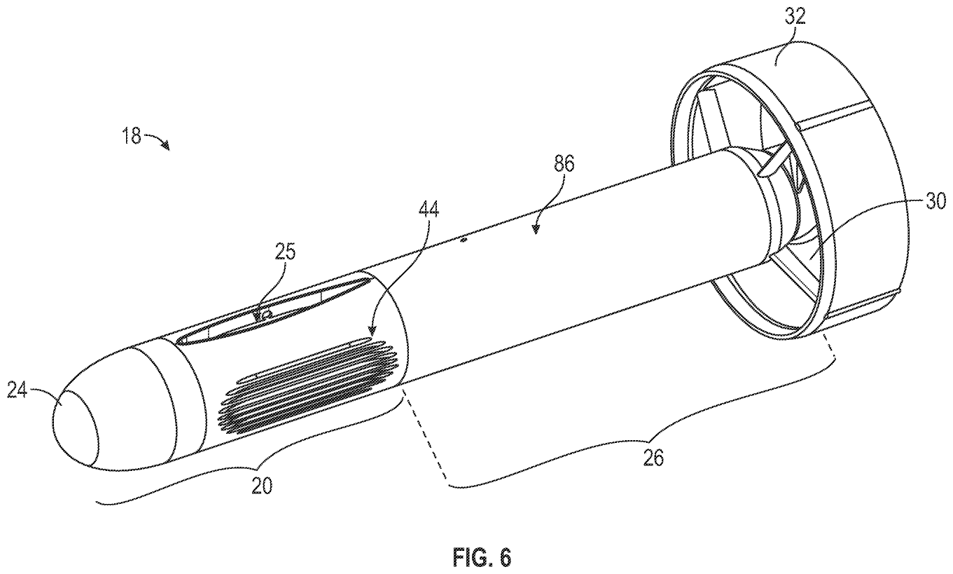

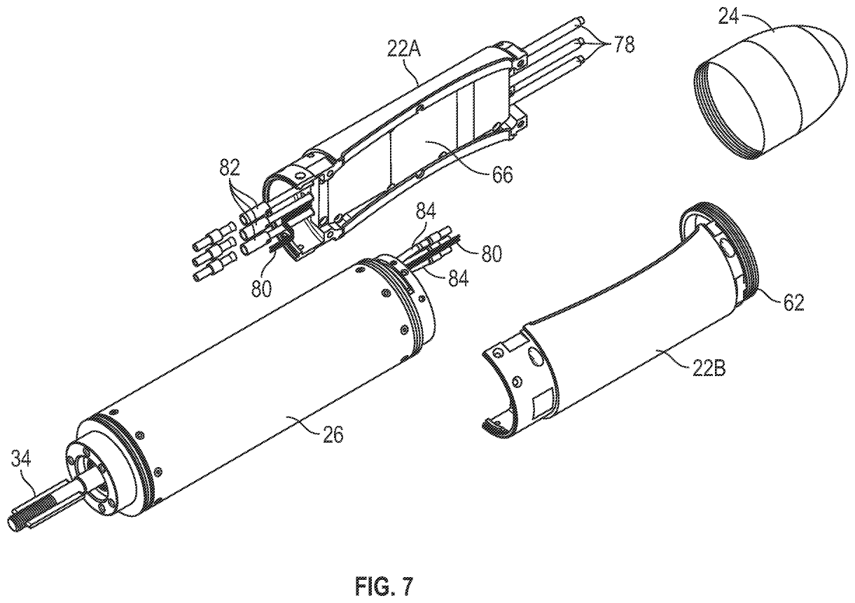

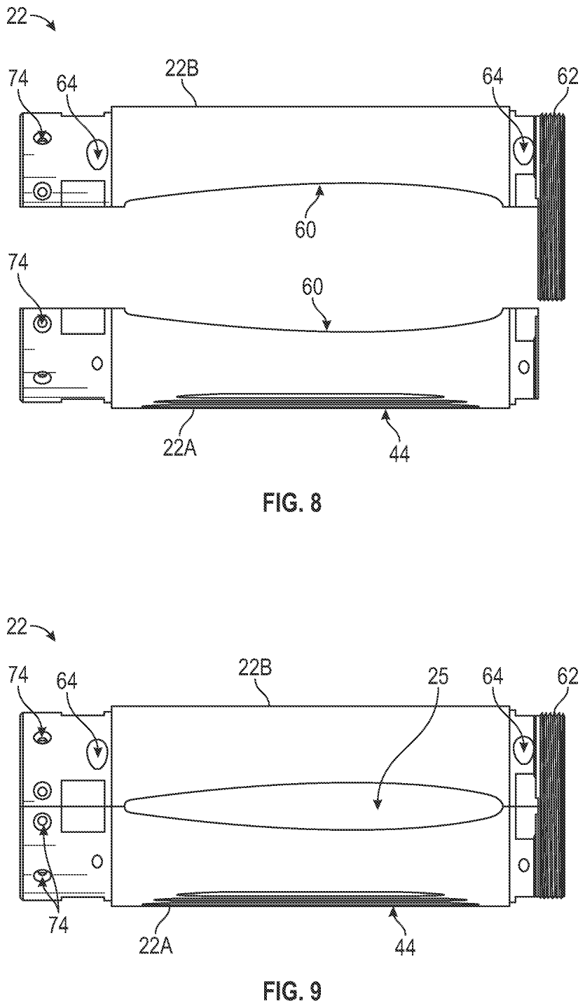

As best seen in FIG. 6, the powertrain assembly 18 preferably includes a nose cone assembly 20 and a motor assembly 26, which may be coupled to each other to form the tubular body of the powertrain assembly 18. The nose cone assembly 20 preferably comprises a nose cone 24 secured to a housing 22, which may comprise two halves 22A and 22B. FIG. 7 illustrates an exploded view of the powertrain assembly 18 with the propeller 30 and propeller guard 32 removed. The two halves 22A, 22B of the housing are shaped so that the two halves 22A, 22B form an opening 25 that conforms to the shape of the mast 14 when the two halves 22A, 22B are fastened together around opposing sides of the mast 14. The mast opening 25 is best seen in FIGS. 6 and 9. To facilitate a tight fit around the mast 14, each of the two halves 22A, 22B may have profiled edges 60 shaped to fit tightly around opposing sides of the mast 14, as best seen in FIG. 8. As shown in FIG. 7, the nose cone 24 preferably has female threads that are compatible with male threads 62 attached to one half 22B of the nose cone housing 22 for fastening the nose cone 24 to the housing 22. The two halves 22A, 22B preferably have threaded openings 64 for fastening the two halves 22A, 22B to each other using bolts, as shown in FIG. 9.

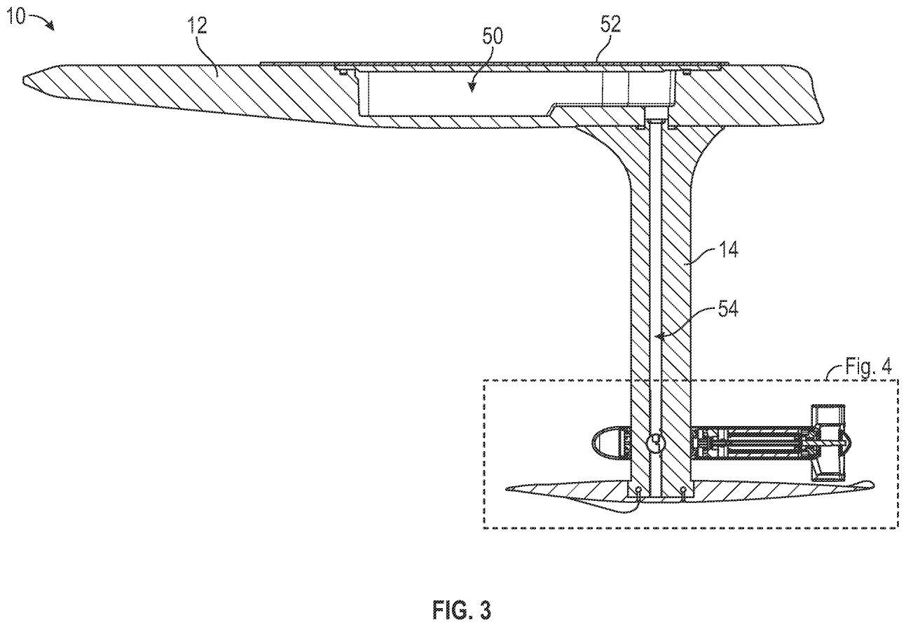

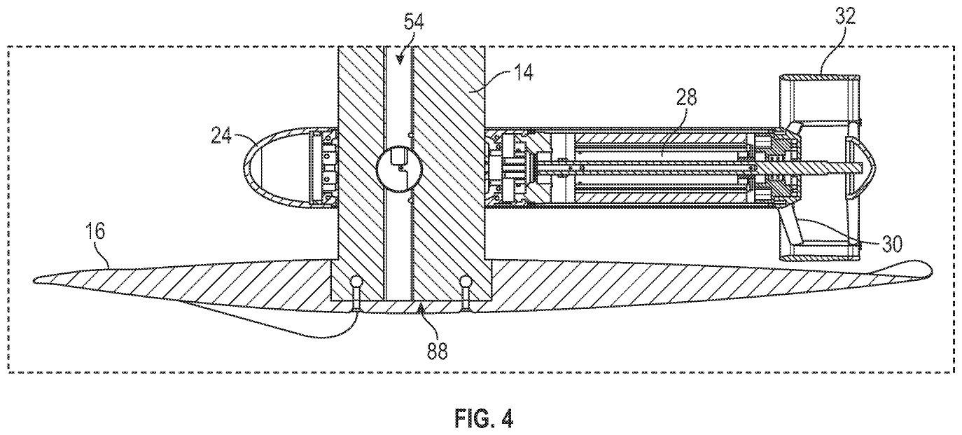

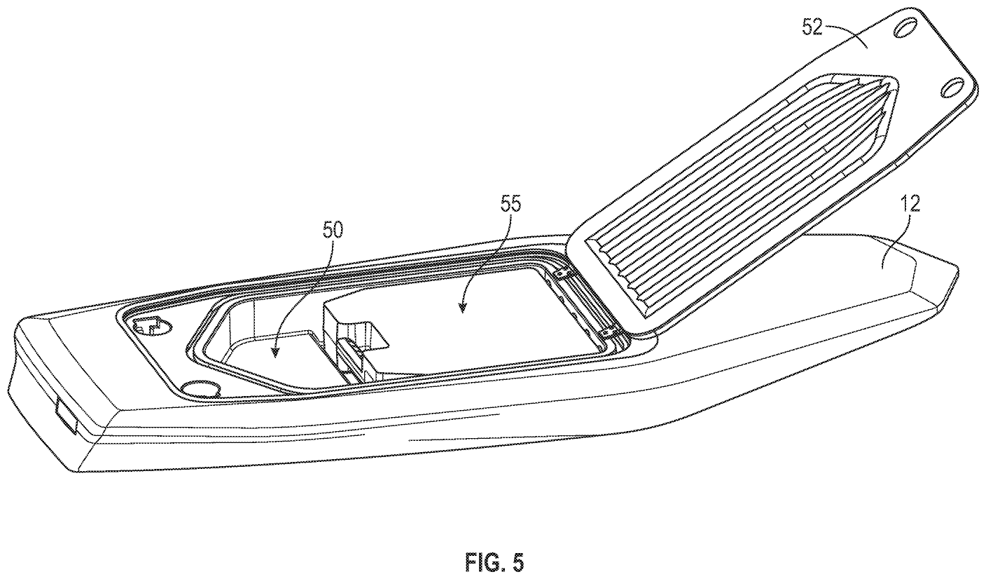

The nose cone assembly 20 preferably houses the ESC 36, which may be housed within one half 22A of the nose cone housing 22, as best seen in FIGS. 11-13. The motor assembly 26 houses the motor 28, as best seen in FIG. 4, which is preferably an electric motor. As shown in FIG. 7, the motor 28 has a drive shaft 34 to which the propeller 30 may be coupled to provide rotational movement of the propeller 30. To provide power to motor 28, the hydrofoil board 10 may comprise a battery 55, which is preferably housed within a compartment 50 inside the board 12, as best seen in FIG. 5. The compartment 50 may be enclosed by a lid 52. As best seen in FIG. 3, the battery 55 may be operably connected to the ESC 36 by wiring 78 that may be passed through conduit 54 built into an interior of the mast 14. The conduit 54 extends from the battery compartment 50 to the lower end 88 of the mast 14 where the wiring 78 may be connected to the ESC 36 through the nose cone 24.

The powertrain assembly 18 comprises various heat-generating components that require cooling during operation of the hydrofoil board 10. The heat-generating components are primarily components of the ESC 36 housed within the nose cone housing 22. These components may include mosfets 42 (metal-oxide-semiconductor field-effect transistors), capacitors 40, and printed circuit boards 38 (PCBs), which may be seen in FIGS. 11 and 13, as well as other components that may be operably connected to the PCBs. Other heat-generating components contained within the powertrain assembly 18 may include components of the motor 28 housed within the motor assembly 26, which is coupled to the nose cone assembly 20. All of the heat-generating components may be passively cooled by the flow of water around the powertrain assembly 18. The powertrain assembly 18 may be configured to facilitate effective heat transfer from these components into the surrounding body of water.

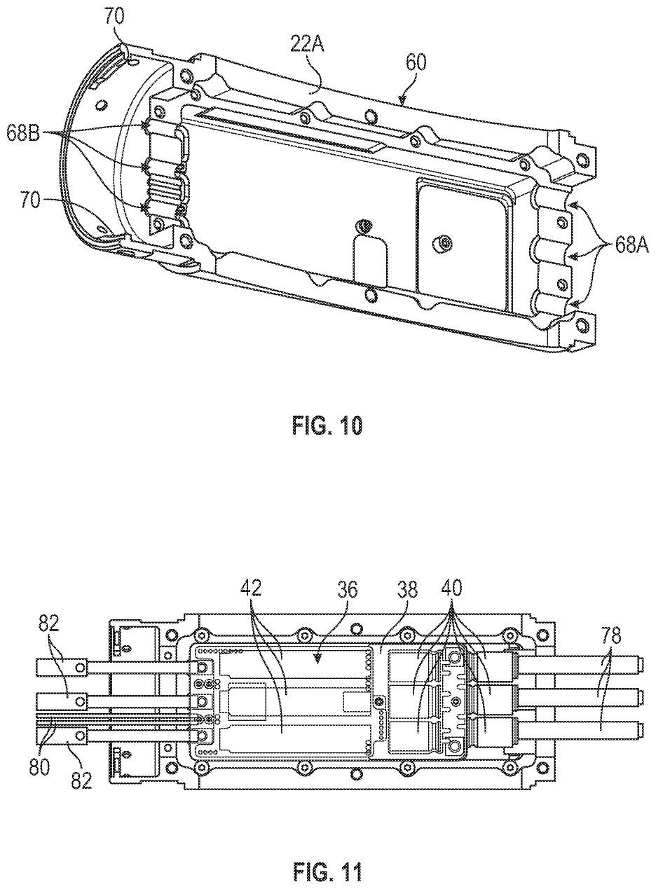

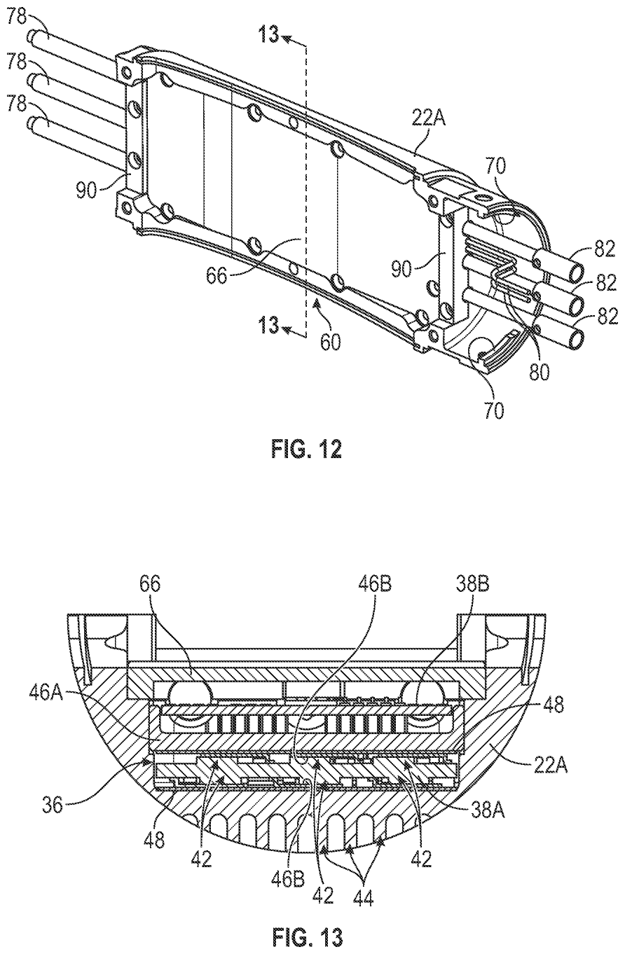

The ESC 36 is preferably housed inside a watertight compartment contained within one half 22A of the nose cone housing 22, as shown in FIGS. 12 and 13. Once the two halves 22A, 22B of the housing 22 are fastened together, the interior of the opposing half 22B does not require a watertight seal. To assemble the powertrain assembly 18, the ESC 36 is first installed within half 22A of the nose cone housing 22. FIG. 10 shows half 22A of the housing 22 before installation of the ESC 36. FIG. 11 illustrates the half 22A of the housing 22 after the installation of the ESC 36 components, including PCBs 38, capacitors 40, and mosfets 42. After installation of these components, a plate 66 is installed onto the half 22A of the housing 22 and sealed to form the watertight compartment containing the ESC 36 components, as best seen in FIG. 12. Before installation of the plate 66, wiring 78 is connected to the ESC 36 for connection to the battery 55, and wiring 80, 82 is also connected to the ESC 36 for connection to the motor 28. As best seen in FIG. 10, the housing 22A preferably has a plurality of wire relief slots 68A, 68B in which the wires can be positioned to provide a watertight fit around all wires 78, 80, 82 entering the ESC 36 compartment. Wires 78 may include two power conducting wires, including power and ground wires, and a cable that may include multiple smaller wires inside the cable. The cable may function as a signal wire bundle that facilitates communication between the battery 55 and the ESC 36. Wires 82 may include three motor phase wires, and wires 80 may include two temperature sensor wires. Wires 82 may be connected directly to wires 84, which are connected to the motor 28, as shown in FIG. 7.

Once all of the ESC 36 components and wiring 78, 80, 82 have been installed, the plate 66 may be fastened to housing 22A using bolts or similar fasteners. In addition, wire relief clamps 90 may also be installed to hold all wiring tightly in place within the wire relief slots 68A, 68B. FIG. 12 illustrates housing 22A with the plate 66 and wire relief clamps 90 installed. To facilitate a watertight seal around the interior compartment housing the ESC 36 components, a silicone compound, such as room temperature vulcanizing (RTV) silicone or a similar compound, may be applied to a gasketing surface on the housing 22A and/or on the plate 66, as well as on the wire relief clamps 90, before fastening the plate 66 and wire relief clamps 90 to the housing 22A. An additional layer of silicone may also be applied to the top and bottom sides of all wires to ensure a redundant seal. The wire relief clamps 90 are preferably utilized to reduce the possibility of breaking the seal on the ESC 36 wires during assembly of the hydrofoil board 10. The silicone may then be allowed to cure to provide a watertight seal around the plate 66 and the wire relief clamps 90, which provides a complete watertight seal within the interior compartment of the housing 22A containing the ESC 36.

As best seen in FIG. 13, the ESC 36 preferably includes two PCBs 38, which may have a plurality of capacitors 40 and mosfets 42 installed on one or more of the PCBs 38, though the capacitors 40 are not shown in FIG. 13. The mosfets 42 and capacitors 40 are generally the components of the ESC 36 that generate the most heat. Preferably, the PCBs 38 are configured such that the mosfets 42 lay out in rows and can be pressed against the inside wall of the tubular body of the nose cone housing 22. To facilitate heat transfer away from the mosfets 42 and capacitors 40, the nose cone assembly 20 preferably comprises an internal heat sink 46 positioned adjacent to heat-generating components of the ESC 36, including the mosfets 42 and capacitors 40. To further facilitate heat transfer, the nose cone assembly 20 preferably further comprises an internal thermal pad 48 positioned adjacent to heat-generating components of the ESC 36, including the mosfets 42 and capacitors 40.

As shown in FIG. 13, the mosfets 42 are preferably installed on one PCB 38A, which may be stacked upon a second PCB 38B. Since heat will not easily conduct from one PCB through the adjacent PCB layer, the ESC 36 preferably utilizes a bracket-style heat sink 46A that is placed between the two PCBS 38A and 38B. The heat sink 46A provides a conduction path to the external walls of the body of the nose cone housing 22A. This heat sink 46A positioned between PCBs 38A and 38B greatly reduces the temperature on the components installed on the PCBs 38A, 38B. Additional smaller heat sinks 46B may be attached directly to the mosfets 42 and PCB 38A. Preferably, as best seen in FIG. 13, the mosfets 42 and the small heat sinks 46B may be soldered onto PCB 38A. PCB 38A may be double-sided and have mosfets 42 installed on both sides. In addition, thermal pads 48 may be installed inside the nose cone housing 22A to transfer heat to the external walls of the housing 22A and to eliminate air gaps. A thermal pad 48 may be placed between the mosfets 42 and the center heat sink 46A to ensure good contact with the heat sink 46A without air gaps. An additional thermal pad 48 may also be placed between the mosfets 42 and a wall of the housing 22A. The PCBs 38A and 38B may be fastened directly to the heat sink 46A, and the heat sink 46A may be fastened directly to the inside of the walls of the nose cone housing 22A to ensure even pressure and good contact with the thermal pads 48. Alternatively, the center heat sink 46A may be fastened to the housing 22A, and the PCBs 38A and 38B may be press fit in place by the heat sink 46A. Additional thermal pads 48 may optionally be placed between the capacitors 40 and the walls of the housing 22A. FIGS. 11 and 13 show one illustrative configuration of PCBs 38, capacitors 40, mosfets 42, heat sinks 46, and thermal pads 48 that may be utilized, though other configurations of some or all of these components may be utilized and still fall within the scope of the present disclosure.

As best seen in FIG. 13, after the installation of all of the components of the ESC 36, some void space remains around the ESC components and within the interior of the compartment. Once the plate 66 and wire relief clamps 90 have been installed and the silicone has been allowed to cure, any remaining void space inside the compartment housing the ESC 36 within the nose cone housing 22A may be filled with a thermal potting compound via fill and vent holes formed in a wall of the nose cone housing 22A. The potting compound has a relatively high thermal conductivity and is dielectric. The potting compound may be injected so that the thermal potting displaces substantially all of the air within the interior of compartment containing the ESC 36. Once the potting compound is injected and allowed to cure, it ensures that no water can leak into the interior of the compartment and thus that no water can contact the components of the ESC 36, including the PCBs 38, capacitors 40, and mosfets 42. The potting compound also allows heat to more easily transfer from all of the heat-generating components into the walls of the tubular body of the nose cone assembly 20, thereby reducing hotspots and component temperatures of chips on the PCBs 38. In addition, the potting compound prevents significant changes in pressure inside the ESC 36 compartment that may otherwise occur due to changes in temperature of the ESC components if the void space around the ESC components were not filled with thermal potting. Such changes in pressure can damage seals over time and allow water to leak into the ESC compartment.

To further facilitate heat removal from the ESC 36 compartment of the nose cone housing 22A into the surrounding water, the tubular body of the powertrain assembly 18 may have external cooling fins 44 disposed on an exterior of the powertrain assembly 18. As best seen in FIGS. 6 and 9, the cooling fins 44 are preferably disposed on the exterior of the nose cone housing 22A to transfer heat away from the mosfets 42 and other heat-generating components of the ESC 36. As best seen in FIG. 13, the cooling fins 44 are preferably machined into the external walls of the housing 22A so that the fins 44 are flush with the tubular body of the powertrain assembly 18 in order to provide a smooth tubular profile to reduce drag as the powertrain assembly 18 moves through the water. Alternatively, the cooling fins 44 may extend away from the external walls of the housing 22A and outward from the tubular body. The cooling fins 44 provide additional surface area for heat transfer and allow water flowing around the exterior of the powertrain assembly 18 to provide cooling deeper into an interior of the ESC housing 22A walls. The tubular body of the powertrain assembly 18, including the cooling fins 44, is preferably constructed of aluminum, which provides efficient heat transfer to the aluminum external walls of the body of the assembly.

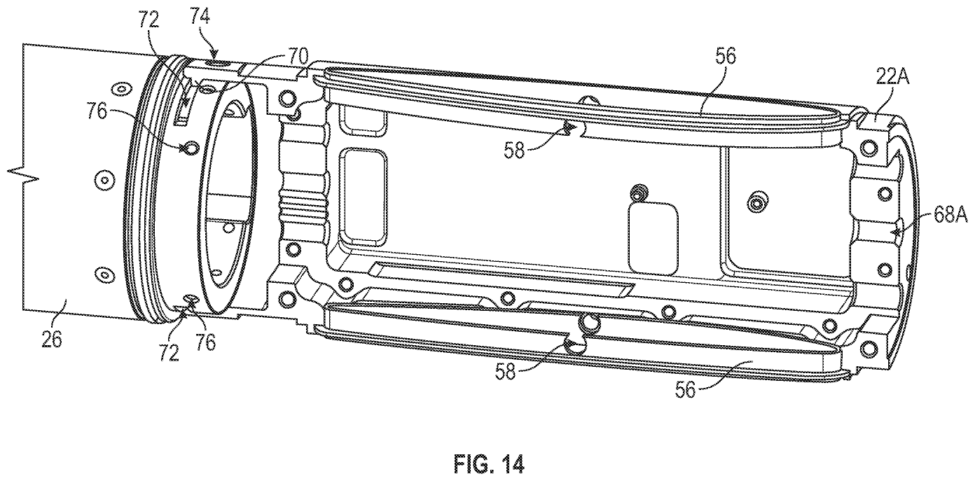

Once the ESC 36 has been fully installed within housing 22A and waterproofed, as shown in FIG. 12, the powertrain assembly 18 may be installed on the mast 14 of the hydrofoil board 10. To do so, the nose cone assembly 20 is assembled and coupled to the motor assembly 26. The nose cone assembly 20 is preferably coupled to the motor assembly 26 by a tongue and groove joint, as best seen in FIG. 14. In addition, gaskets 56 may be utilized to form a seal between the two halves 22A, 22B of the nose cone housing 22 and the mast 14. FIG. 14 illustrates two fully formed gaskets 56, though each gasket 56 preferably comprises two halves, which may each be installed onto one half 22A, 22B of the nose cone housing 22 to form the full gasket 56 when the two halves 22A, 22B are fastened together. In addition, each gasket 56 may optionally have two aligned dowel pin holes 58 in opposing sides of each gasket 56. Dowel pins may be attached to the mast 14 in a defined position so that the dowel pins may be inserted into the holes 58 in the gaskets 56 to help facilitate accurate alignment when the two halves 22A, 22B of the nose cone housing 22 are clamped together around the mast 14.

As best seen in FIG. 14, each half 22A, 22B of the housing 22 may comprise a tongue 70, and the motor assembly 26 may have grooves 72 configured to receive the tongue 70 of each half 22A, 22B of the housing 22. In addition to the tongue 70 and groove 72 joint, each half 22A, 22B of the housing 22 preferably has a plurality of bolt openings 74 configured to align with a plurality of bolt holes 76 in the motor housing 26 when the tongue 70 and groove 72 joint is formed. Thus, the nose cone assembly 20 and motor assembly 26 may be coupled together by both bolts and by a tongue 70 and groove 72 joint. The tongue 70 and groove 72 joint is able to better handle the torque of the motor 28 over time, thereby reducing the load on the fasteners.

To install the powertrain assembly 18, the components may be arranged as shown in FIG. 7. The two halves of each gasket 56 are installed onto the nose cone housing halves 22A and 22B. Wiring from the battery 55 is run through the mast 14 via the interior conduit 54 and connected to the ESC 36 by connecting to the wiring 78 installed on the ESC 36. This wiring 78 may be connected through the nose cap 24 and through the interior of the half 22B of the housing 22 that does not house the ESC 36. Wiring 80, 84 from the motor assembly 26 may also be connected to the wiring 80, 82 installed on the ESC 36. The two halves 22A, 22B of the nose cone housing 22 may then be positioned on opposite sides of the mast 14 and fastened together using bolts that are inserted and threaded into the threaded openings 64 on each half 22A, 22B of the nose cone housing 22. The nose cap 24 may then be threaded onto the threaded section 62 of the housing 22. When fastening the housing halves together, the halves 22A and 22B should be positioned around the motor assembly 26 so that the tongue 70 of each half 22A, 22B is inserted into one of the grooves 72 of the motor assembly 26. Fasteners may then be inserted through openings 74 and threaded into holes 76 in the motor assembly 26 to complete the coupling of the motor assembly 26 to the nose cone assembly 20. An optional motor assembly sleeve 86 may then be installed over the motor assembly 26, as best seen in FIG. 6, to conceal fasteners and other hardware on the motor assembly 26 and the nose cone assembly 20. The sleeve 86 and nose cone assembly 20 are preferably configured to fit flush with each other to form the tubular body of the powertrain assembly 18 to reduce drag in the water. The propeller 30 may then be coupled to the propeller drive shaft 34, and the propeller guard 32 by be secured to the motor assembly 26.

The cooling features described herein, including the machined cooling fins 44, heat sinks 46, thermal pads 48, and thermal potting, all function to increase the efficiency of heat transfer away from the ESC 36 components and into the external walls of the nose cone assembly 20, which forms a portion of the powertrain assembly 18, and into the body of water in which the hydrofoil board 10 is being operated. These cooling features function in combination with the water flowing around the powertrain assembly 18 that effectively transfers heat away from the external walls of the powertrain assembly. Thus, the present system provides a submersion-cooled powertrain unit 18 that allows the ESC 36 to be housed in a submerged, waterproof compartment. The motor 28 is preferably a brushless direct current (BLDC) motor, which also generates heat. The flow of water around the motor assembly 26 also provides cooling of the motor 28. It should be understood by one skilled in the art that other internal configurations of the ESC 36 may be utilized to provide speed control to the motor 28 and still fall within the scope of the present disclosure if the ESC 36 is installed in a submerged position and is passively submersion-cooled. Various configurations of heat sinks 46, thermal pads 48, and thermal potting, or any combinations thereof, may be utilized in different positions within the interior of the powertrain assembly 18. The size, shape, and internal positioning of these components may be altered to accommodate various ESC designs depending on the specific application and performance specifications of the hydrofoil board 10. The purpose of these components is to function in combination with the flow of water around the powertrain assembly 18 during normal operation in order to facilitate efficient heat transfer. Due to the enhanced efficiency of heat transfer due to the flow of water, the size of the heat sink 46A may also be minimized. In addition, the size of the heat sink 46A may be minimized so that it fits inside the streamlined tubular powertrain assembly 18.

The tubular body of the powertrain assembly 18, including the nose cone assembly 20 and the motor assembly 26, is preferably constructed of anodized aluminum to resist corrosion, particularly due to use in salt water environments, which is common for hydrofoil boards. After anodizing, the tubular body is preferably machined again so that bare aluminum is exposed on the interior side of the walls of the tubular body. This ensures minimal thermal resistance near the PCB heat-generating components, as each layer of anodization increases the resistance to heat transfer from the heat-generating components into the walls of the tubular body. The anodization thickness may be optimized, which may depend on the specific application, to provide a good balance between ensuring that the housing does not corrode with normal care over the life of the product, while also minimizing thermal resistance to provide more efficient heat transfer.

It will be appreciated that the configurations and methods shown and described herein are illustrative only, and that these specific examples are not to be considered in a limiting sense, because numerous variations are possible. The subject matter of the present disclosure includes all novel and non-obvious combinations and sub-combinations of the various systems and configurations, and other features, functions, and/or properties disclosed herein. It is understood that versions of the invention may come in different forms and embodiments. Additionally, it is understood that one of skill in the art would appreciate these various forms and embodiments as falling within the scope of the invention as disclosed herein.

1. An electric hydrofoil board, comprising:
a board;
a mast attached to a bottom side of the board and extending downwardly from the board;
a hydrofoil attached to a bottom end of the mast; and
a powertrain assembly attached to the mast, wherein the powertrain assembly comprises a motor and an electronic speed controller operably coupled to the motor and configured to vary the speed of the motor,
wherein the powertrain assembly is disposed at a position on the mast so that both the motor and the electronic speed controller of the powertrain assembly are submerged when the electric hydrofoil board is in an upright position for normal use in water,
wherein the electric hydrofoil board does not include an internal coolant circulation system.

2. The electric hydrofoil board of claim 1, wherein the powertrain assembly is attached to a lower end of the mast and disposed at a position above the hydrofoil.

3. The electric hydrofoil board of claim 1, wherein the powertrain assembly has external cooling fins disposed on an exterior of the powertrain assembly.

4. The electric hydrofoil board of claim 1, wherein the powertrain assembly comprises an internal heat sink positioned adjacent to heat-generating components of the electronic speed controller.

5. The electric hydrofoil board of claim 1, wherein the powertrain assembly comprises an internal thermal pad positioned adjacent to heat-generating components of the electronic speed controller.

6. The electric hydrofoil board of claim 1, wherein the powertrain assembly comprises a nose cone assembly that houses the electronic speed controller and a motor assembly that houses the motor, wherein the nose cone assembly and the motor assembly are coupled to each other.

7. The electric hydrofoil board of claim 6, wherein the nose cone assembly comprises a nose cone secured to a housing, wherein the housing comprises two halves, wherein each half is shaped so that the two halves form an opening that conforms to the shape of the mast when the two halves are fastened together around opposing sides of the mast.

8. The electric hydrofoil board of claim 6, wherein the nose cone assembly has external cooling fins disposed on an exterior of the nose cone assembly.

9. The electric hydrofoil board of claim 6, wherein the nose cone assembly comprises an internal heat sink positioned adjacent to heat-generating components of the electronic speed controller.

10. The electric hydrofoil board of claim 6, wherein the nose cone assembly comprises an internal thermal pad positioned adjacent to heat-generating components of the electronic speed controller.

11. The electric hydrofoil board of claim 6, wherein the nose cone assembly includes a watertight compartment that houses the electronic speed controller, wherein void space within the compartment is filled with a thermal potting compound.

12. The electric hydrofoil board of claim 6, wherein the nose cone assembly and the motor assembly are coupled to each other by a tongue and groove joint.

13. The electric hydrofoil board of claim 1, further comprising a battery operably connected to the electronic speed controller and configured to provide power to the motor at variable speeds.

14. The electric hydrofoil board of claim 13, wherein the battery is disposed within a compartment within the board, wherein the battery is operably connected to the electronic speed controller by wiring disposed within an interior of the mast.

15. (canceled)

16. A powertrain assembly comprising a nose cone assembly that houses an electronic speed controller and a motor assembly that houses a motor, wherein the electronic speed controller is operably coupled to the motor and configured to vary the speed of the motor, wherein the nose cone assembly and the motor assembly are coupled to each other,
wherein the nose cone assembly comprises a nose cone secured to a housing,
wherein the housing comprises two halves, and wherein each half is shaped so that the two halves form an opening that conforms to the shape of a mast of an electric hydrofoil board when the two halves are fastened together around opposing sides of the mast,
wherein the powertrain assembly does not include an internal coolant circulation system.

17. The powertrain assembly of claim 16, wherein the nose cone assembly has external cooling fins disposed on an exterior of the nose cone assembly.

18. The powertrain assembly of claim 16, wherein the nose cone assembly comprises an internal heat sink positioned adjacent to heat-generating components of the electronic speed controller.

19. The powertrain assembly of claim 16, wherein the nose cone assembly comprises an internal thermal pad positioned adjacent to heat-generating components of the electronic speed controller.

20. The powertrain assembly of claim 16, wherein the nose cone assembly and the motor assembly are coupled to each other by a tongue and groove joint.
